(19) United States
(12) Patent Application Publication
(10) Pub. No.: US 2021/0024658 A1
(43) Pub. Date: Jan. 28, 2021

(54) METHOD FOR CO-PRODUCTION OF GELLING AND EMULSIFYING PECTINS FROM CHICORY/JERUSALEM ARTICHOKE PULP

(71) Applicant: SOUTH CHINA UNIVERSITY OF TECHNOLOGY, Guangzhou, Guangdong (CN)

(72) Inventors: Hecheng MENG, Guangzhou, Guangdong (CN); Shujuan YU, Guangzhou, Guangdong (CN); Xiaoming GUO, Guangzhou, Guangdong (CN); Fang PI, Guangzhou, Guangdong (CN)

(21) Appl. No.: 17/041,294

(22) PCT Filed: Oct. 24, 2018
(86) PCT No.: PCT/CN2018/111614

§ 371 Date: Sep. 24, 2020

(30) Foreign Application Priority Data
Mar. 27, 2018 (CN) 201810258498.X

(51) Int. Cl. C08B 37/00; A23L 29/10; A23L 29/231

(52) U.S. Cl. CPC C08B 37/0048; A23V 2002/00; A23L 29/231; A23L 29/10

(57) ABSTRACT

The disclosure discloses a method for co-production of gelling and emulsifying pectins from chicory/Jerusalem artichoke pulp, including raw material pretreatment, extraction, filtration, concentration, alcohol precipitation, and drying. According to the cell wall structure and tissue characteristics of chicory/Jerusalem artichoke pulp, the disclosure targetedly adopts the salt extraction and the dilute acid extraction to sequentially produce gelling and emulsifying pectin products. The gelling chicory/Jerusalem artichoke pectin has characteristics of simple molecular structure, high purity, low degree of acetylation (DA), and high gel strength; and the emulsifying chicory/Jerusalem artichoke pectin has excellent emulsifying properties. The extraction method for chicory/Jerusalem artichoke pectin in the disclosure can provide two types of pectin at the same time, broaden the application range of chicory/Jerusalem artichoke pectin, and improve the processing utilization of chicory/Jerusalem artichoke pulp.

### CROSS REFERENCE TO RELATED APPLICATIONS

This application is a 35 U.S.C. § 371 U.S. national phase entry of International Application No. PCT/CN2018/111614 having an international filing date of Oct. 24, 2018, which claims the benefit of foreign Chinese Application No. 201810258498.X filed Mar. 27, 2018, each of which is incorporated herein by reference in its entirety.

### TECHNICAL FIELD

The disclosure relates to a pectin, in particular to a method for co-production of gelling and emulsifying pectins from chicory/Jerusalem artichoke pulp, and belongs to the field of food processing.

### BACKGROUND

Chicory (Cichorium intybus L) is rich in fructooligosaccharide (FOS) (inulin) and is a famous economic crop. Chicory is suitable for being cultivated in fertile and acidic soil. China has the largest chicory-growing area in Asia. Jerusalem artichoke (Helianthus tuberosus (L. 1753)), also known as sunroot or sunchoke, is a perennial herbaceous plant. Jerusalem artichoke is 1 to 3 meters tall and has massive underground stems and fibrous roots. The stem of Jerusalem artichoke is erect, branched, and covered with white short shags or setae. Jerusalem artichoke native to North America was introduced to Europe in the 17th century and then to China. The underground tubers of Jerusalem artichoke, rich in fructose polymers such as starch and inulin, can be eaten (boiled or made into porridge), pickled into pickles, sun-cured into dehydrated Jerusalem artichoke, or used as raw materials for preparing starch and alcohol.

For a long time, chicory/Jerusalem artichoke is planted mainly to provide chicory leaves for eating and tubers of chicory/Jerusalem artichoke for producing inulin. A large amount of by-product (chicory/Jerusalem artichoke pulp) is produced during the process of producing inulin from Chicory/Jerusalem artichoke. At present, the chicory/Jerusalem artichoke pulp composed of protein, carbohydrates, inorganic ash and the like is mainly used for feed processing. However, the feed processing using chicory/Jerusalem artichoke consumes a large amount of energy and creates a low added value. It has become an important issue in the chicory/Jerusalem artichoke processing industry to further develop and utilize a new processing way that can increase the added value of chicory/Jerusalem artichoke pulp.

Chicory/Jerusalem artichoke pulp is rich in dietary fiber. Pectin is the main component of the dietary fiber in chicory/Jerusalem artichoke pulp. Chicory/Jerusalem artichoke pulp has a pectin content varying from 11% to 29% depending on the species, and the pectin is of good quality. As chicory/Jerusalem artichoke pulp is a potential raw material for producing pectin, extensive attention has been paid to the chicory/Jerusalem artichoke processing technology in recent years. For example, Chinese patent 200910018964.8 discloses a method for continuously extracting pectin and dietary fiber from Jerusalem artichoke and/or chicory residues; and Chinese patent 201410157396.0 discloses a method for continuously preparing inulin and pectin using Jerusalem artichoke and/or chicory. The above-mentioned inventions all adopt the traditional hot acid method to produce chicory/Jerusalem artichoke pectin. Due to the poor selectivity of hot acid extraction, heteropolysaccharides are easy to be introduced in the product, which reduces the purity and uniformity of the product, and makes the product have no distinctive characteristics and prominent performance Studies have found that chicory pectin has a low degree of methyl-esterification (DM), but a higher degree of acetylation (DA) than commercial orange peel and apple pomace pectin. When using the hot acid method to prepare chicory/Jerusalem artichoke pectin, foreign scholars Rober et al. (doi: 10.1021/jf061992g) found that the DA of chicory/Jerusalem artichoke could be as high as 16%. Since high DA is not conducive to the formation of a gel network structure by low-ester pectin with Ca²⁺, the gelling performance of the low-ester chicory/Jerusalem artichoke pectin will be greatly reduced. It can be seen that developing a method for producing chicory/Jerusalem artichoke pectin with low DA will help improve the gelling performance of chicory/Jerusalem artichoke pectin, and will play an important role in improving the quality of chicory/Jerusalem artichoke pectin.

### SUMMARY

The disclosure is intended to overcome the problem that the chicory/Jerusalem artichoke pectin prepared by the traditional hot acid method has high DA, poor structural uniformity and low gel strength, and to provide a method for co-production of gelling and emulsifying pectins with low DA from chicory/Jerusalem artichoke pulp, where, the secondary chicory/Jerusalem artichoke pulp is reused to produce emulsifying chicory/Jerusalem artichoke pectin.

In the disclosure, low-ester gelling chicory/Jerusalem artichoke pectin is first extracted by salt extraction, the pectin is dissolved at a slightly-acidic (pH: 5.5 to 6.0) environment, and deacetylation is simultaneously induced and controlled to reduce the DA of the chicory/Jerusalem artichoke pectin, thereby improving the gelling performance of the product; and then the secondary chicory/Jerusalem artichoke pulp is reused to produce low-ester emulsifying chicory/Jerusalem artichoke pectin by the hot acid method. The disclosure provides a method for co-production of low-ester gelling and emulsifying pectins from chicory/Jerusalem artichoke pulp, which improves the utilization of raw materials, makes the product have outstanding structural characteristics and performance, and has a promising application prospect.

The gelling chicory/Jerusalem artichoke pectin produced by the method of the disclosure has characteristics of low DA, low DM, high purity and excellent uniformity, and exhibits a prominent gel strength in Ca²⁺-containing food systems. The low-ester emulsifying chicory/Jerusalem artichoke pectin has characteristics of high DA, high protein content and low DM, and can well stabilize oil-in-water emulsions.

The principle of the disclosure is to use a chelating agent and a dilute acid to release the binding of calcium ions and cell wall materials to gelling and emulsifying pectins, which exhibits high selectivity, and retains the structural integrity of pectin molecules.

The disclosure involves readily-available raw materials and simple operations, can effectively improve the processing degree and added value of chicory/Jerusalem artichoke pulp, facilitates the large-scale production and promotion, and has promising application prospects. The disclosure adopts the chicory/Jerusalem artichoke pulp produced during the production of FOS and inulin from chicory/Jerusalem artichoke as raw materials. The pectin product does not need to be decolorized, and exhibits high color quality, which allows no residual bleaching agent.

The objectives of the disclosure are achieved by the following technical solutions.

The disclosure provides a method for co-production of gelling and emulsifying pectins from chicory/Jerusalem artichoke pulp, including the following steps:

(1) pretreatment of raw material: removing impurities from chicory pulp, then rinsing with water until the rinse is clear, and drying, crushing and sieving through a 20 to 60 mesh sieve to give the pretreated chicory pulp for later use;

(2) preparation of gelling pectin

2a. soaking in a chelating agent solution: mixing the chicory pulp with a chelating agent solution at a mass-volume ratio (kg:L) of 1:20 to 1:30, and conducting soaking at 60° C. to 90° C. for 1 h to 4 h, with an extraction pH of 5.5 to 6.0, where, gas stirring is conducted during the soaking process to achieve a rotational speed of 60 rpm to 500 rpm, and the chelating agent is ammonium oxalate or sodium hexametaphosphate;

2b. separation of liquid and residue: separating the liquid and the residue by filtration or centrifugation to give a pectin liquid, and reserving the residue for later use;

2c. concentration: concentrating the pectin liquid to a volume ⅓ to ⅕ of the original volume;

2d. alcohol precipitation: mixing the pectin concentrate with 80% to 95% ethanol at a volume ratio of 1:1 to 1:5, stirring a resulting mixture for 10 min to 30 min, and then standing for 1 h to 6 h;

2e. washing: collecting the pectin precipitate, and then washing the pectin with an ethanol solution;

2f. drying: removing ethanol to give gelling pectin;

(3) preparation of emulsifying pectin

3a. pretreatment of raw material: grinding the residue obtained in step 2b into a paste by a wet grinder; then mixing the paste with a dilute acid solution at a mass-volume ratio (kg:L) of 1:10 to 1:30; conducting soaking at 60° C. to 80° C. for 1 h to 3 h under mechanical stirring at 60 rpm to 600 rpm, with a pH of 2 to 3.5; and standing for 1 h to 2 h; where, the solid material in the grinder has a particle size of 1 μm to 1,000 μm;

3b. separation of liquid and residue: separating the liquid and residue obtained in step 3a by filtration or centrifugation to give a pectin liquid for later use;

3c. concentration: concentrating the pectin liquid using a filter membrane to a volume ¼ to ⅕ of the original volume, where, the filter membrane has a pore size of 1 KD to 200 KD;

3d. drying: spray-drying the pectin concentrate to remove moisture to give emulsifying pectin.

To further achieve the objective of the disclosure, preferably, the chelating agent solution has a concentration of 0.2 to 1 g/100 mL.

Preferably, the filtration in steps 2b and 3b is conducted by a plate and frame filter press or a leaf filter.

Preferably, the centrifugation in steps 2b and 3b is conducted for 10 min to 60 min by a batch or continuous centrifuge at a rotational speed of 1,000 rpm to 10,000 rpm.

Preferably, the concentration in steps 2c and 3c is conducted under vacuum at 50° C. to 80° C., with a vacuum degree of 0.01 MPa to 0.05 MPa.

Preferably, the ethanol solution used for washing in steps 2e has a concentration of 70% to 90% (v/v).

Preferably, the dilute acid in step 3a is one of hydrochloric acid, nitric acid, sulfuric acid, and citric acid.

Preferably, in steps 2f and 3d, the pectin is dried by one or more of a spray dryer, an airflow dryer, and fluidized bed and airflow dryer.

Compared with the prior art, the disclosure has the following advantages.

(1) The disclosure uses different extraction solvents to sequentially produce gelling and emulsifying pectins from chicory/Jerusalem artichoke pulp, which can make full use of the different pectin components in chicory/Jerusalem artichoke pulp, and significantly improve the processing utilization and added value of chicory/Jerusalem artichoke pulp.

(2) The disclosure adopts the salt extraction to produce gelling pectin from chicory/Jerusalem artichoke pulp, which requires mild extraction conditions, avoids the degradation of pectin molecules under the intense action of hot acids, and makes the product have advantages of large molecular weight, low DA and large gel strength.

(3) The emulsifying pectin produced from chicory/Jerusalem artichoke pulp in the disclosure includes hydrophobic structures such as acetyl groups and glycoproteins, has the ability to stabilize oil-in-water emulsions, and shows promising application prospects in acidic protein beverages.

### BRIEF DESCRIPTION OF DRAWINGS

FIG. 1 shows the gelatination of the gelling chicory pectins obtained in Examples 1 to 3.

FIG. 2 shows the storage modulus and loss modulus of the gelling chicory pectin obtained in Example 1 measured by scanning.

FIG. 3 shows the average particle size distribution of the emulsifying chicory pectins obtained in Examples 1 to 3.

FIG. 4 shows the emulsification of the emulsifying chicory pectin.

FIG. 5 shows the standard curve of galacturonic acid during the test.

FIG. 6 shows the molecular weight distribution curve of gelling and emulsifying chicory pectins (Example 1).

### DETAILED DESCRIPTION

The disclosure will be described in detail below in conjunction with examples, but the following examples are not intended to limit the implementation. Those of ordinary skill in the art may make modifications or variations in other forms based on the above description. There is no need and no way to exhaust all of the implementations. Obvious changes or variations made thereto shall still fall within the protection scope of the disclosure.

In Tables 1 to 3 involved in the examples, the relevant detection methods are described as follows:

1) The moisture content is determined by the direct drying method, which is implemented in accordance with GB 5009.3-2016.

2) The galacturonic acid content is determined by the 3-phenylphenol coloration method.

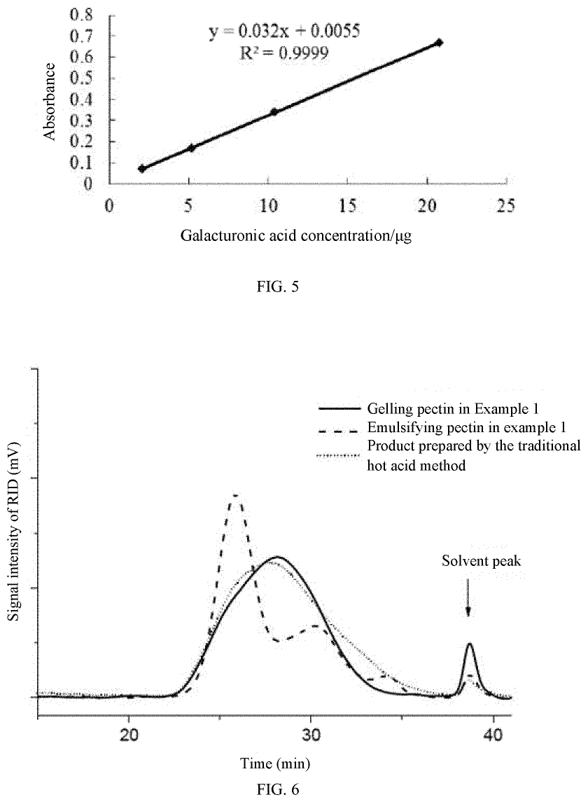

(1) GalA standard curve: A GalA standard solution (50 μg/mL) is prepared, and 40 μL, 120 μL, 240 μL, 360 μL and 400 μL of the standard are pipetted and added to a 10 mL test tube with stopper, separately; then 360 μL, 280 μL, 160 μL, 40 μL and 0 μL of deionized water are added correspondingly, and 2.5 mL of concentrated sulfuric acid is added to each of the tubes under an ice bath; and a resulting mixture is vortexed for thorough mixing, and then placed in a 100° C. water bath for 5 min until polysaccharides are completely hydrolyzed. Then 50 μL of chromogenic reagent is added, and 50 μL of 0.5% NaOH solution is added to the blank sample. After the samples stand for a period of time, zeroing is conducted using two blank samples. The absorbance is determined at a wavelength of 520 nm. Standard curve equation: y=0.032 x+0.0055 (where: y is absorbance; x is the content of D-galacturonic acid (μg), R²=0.9999), as shown in FIG. 5.

(2) Determination of GalA in pectin samples: 5 mg of pectin sample is weighed, completely dissolved, and diluted to 100 mL; 400 μL of the sample solution is added to a 10 mL test tube with a stopper; and the remaining steps are the same as above. 3 replicates are set for each sample.

3) The protein content is determined by the Kjeldahl method, with a protein conversion coefficient of 6.25, which is implemented according to GB 5009.5-2016.

4) The ash content is determined by the burning method, which is implemented in accordance with GB 5009.4-2016.

5) The DM and DA are determined by high-performance liquid chromatography (HPLC).

A mixture of i-propanol and water (1:1) is adopted as a saponification liquid. 25 mg of pectin sample is weighed and added to a 2 mL centrifuge tube, then 1 mL of saponification liquid is added, and the mixture is subjected to saponification at 4° C. for 3 h. After the saponification, the reaction solution is centrifuged at 10,000 r/min for 5 min, and the supernatant is filtered through a 0.22 μm filter membrane and then determined by high-performance anion-exchange chromatography (HPAEC). Chromatographic conditions: column: Aminex HPX-87H, Bio-Rad, USA; mobile phase: 5 mmol/L H₂SO₄; column temperature: 25° C.; flow rate: 0.5 mL/min; gradient elution.

6) The weight average molecular weight (WAMW) is determined by (High-performance size-exclusion chromatography)size-exclusion chromatography (HPSEC).

The WAMW (Mw) of pectin is measured by gel size-exclusion chromatography (HPSEC). The pectin sample is prepared into a 1 mg/mL solution, and the sample solution is filtered through a 0.45 μm filter membrane before being determined. Chromatographic conditions: Ultrahydragel Guard (40 mm×6 mm), Ultrahydrogel 2000 (300 mm×7.5 mm) and Ultrahydrogel 1000 (300 mm×7.5 mm) in series; mobile phase: 100 mmol/L NaNO₃; flow rate: 0.6 mL/min; detector: refractive index detector (RID); column temperature: 35° C.; injection volume: 100 μL. The dextran standard (Mw=11.6 kDa to 608 kDa) is used to establish a molecular weight regression curve, and the Mw is calculated by Empower software (Version 2.0, Waters, USA).

7) The storage modulus and loss modulus of gel are determined by the rotational rheometer method.

The G′ and G″ of chicory pectin gel are determined with a Haake rheometer (model: RHEOSTRESS 600). Deformation scanning is conducted by vibration test. A 1% pectin solution is prepared at 85° C., and the pH is adjusted to 3.5. 2 mL of the sample solution is pipetted and rapidly added to the turnplate of the rheometer dropwise, and then silicone oil is added dropwise after the turnplate gap is adjusted. The turnplate temperature is set to 85° C., and temperature scanning starts after the temperature is held for 2 min Shearing deformation: 0.001% to 100%; shearing frequency: 1 Hz; cooling rate: 5° C./min; and target temperature: 25° C. The change in storage modulus G′ and loss modulus G″ is recorded.

### Example 1

(1) Pretreatment of raw material: Fresh chicory was washed, cut into shreds, and then soaked in purified water at 80° C. for 1 h. The liquid and the residue were separated. The filtrate would be used for extracting inulin and FOS. The residue was rinsed with water until the rinse was clear, and then drained; then sugar and other impurities were removed from the residue; and the resulting residue was oven-dried to give chicory pulp. The obtained dry chicory pulp had the following main components: 21% of cellulose, 23% of hemicellulose, 1% of lignin, 27% of pectin, 8% of protein, and 0.35% of ash. The chicory pulp was crushed into fine particles and sieved through a 20-mesh sieve for later use.

(2) Preparation of gelling pectin

2a. Soaking in a chelating agent solution: 15 kg of the pretreated chicory pulp was mixed with 300 L of ammonium oxalate solution (0.5 g/L). The chicory pulp and the ammonium oxalate solution had a ratio of 1:20 (kg:L). Soaking was conducted at 80° C. for 2 h, with an extraction pH of 5.8. Gas stirring was conducted during the soaking process to achieve a rotational speed of 120 rpm.

2b. Separation of liquid and residue: The mixture obtained after the soaking in a chelating agent solution was subjected to solid-liquid separation in an SS300 three-column centrifuge at 1,900 rpm for 15 min to give a pectin liquid, and the residue was reserved for later use.

2c. Concentration: The pectin liquid was concentrated to have a volume ¼ of the original volume in a vacuum concentration tank. The concentration was conducted at 60° C. under a pressure of −0.08 Mpa.

2d. Alcohol precipitation: The pectin concentrate was mixed with 90% (volume concentration) ethanol at a volume ratio of 1:3, and a resulting mixture was stirred for 15 min and then stood for 4 h.

2e. Washing: The pectin precipitate was collected and then washed with an ethanol solution with a volume fraction of 70%. The ethanol solution was used at a volume 3 times that of the pectin precipitate.

2f. Drying: The resulting pectin was dried at 45° C. for 10 h to remove ethanol and moisture to give gelling pectin.

Preparation Method of Gel

A 1% (mass concentration) pectin solution was prepared, and the pH was adjusted to 3.5. The pectin solution was heated to 70° C., then an appropriate amount of CaCl₂ solution (with a mass concentration of 1%) was added, and the Ca²⁺ concentration was adjusted to 5 mM. The obtained solution stood at room temperature, and gel was formed after the temperature decreased to 30° C.

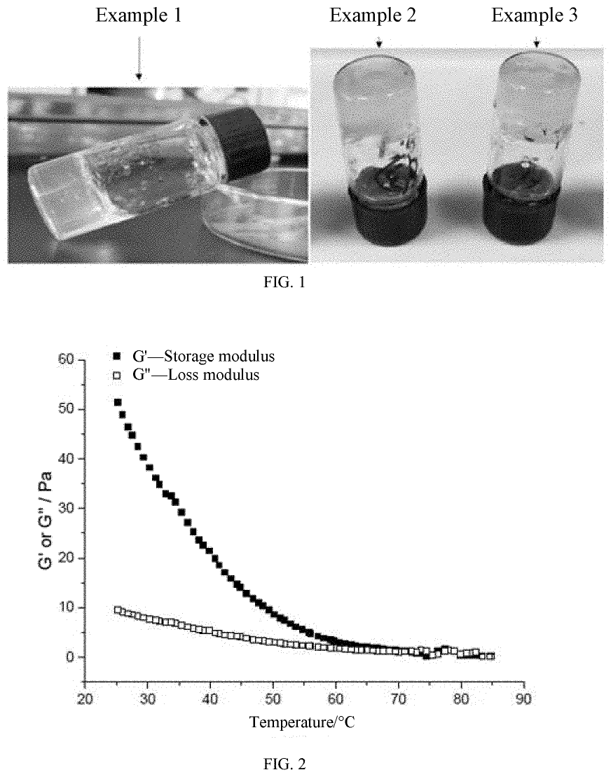

The test results are shown in Table 1. The gelling pectin includes 76.3% of galacturonic acid, exhibiting a high purity, and has a DM and DA of 34% and 7%, respectively. Therefore, the pectin is low-ester pectin. At a mass concentration of 0.5% to 3% and a temperature of 30° C., the gelling pectin can form a colorless and transparent gel with 2 mM to 50 mM Ca²⁺ (see FIG. 1).

Determination Method of Storage Modulus (G′) and Loss Modulus (G″)

The G′ and G″ of chicory pectin gel were determined with a Haake rheometer (model: RHEOSTRESS 600). Deformation scanning was conducted by vibration test. A 1% pectin solution was prepared at 85° C., and the pH was adjusted to 3.5. 2 mL of the sample solution was pipetted and rapidly added to the turnplate of the rheometer dropwise, and then silicone oil was added dropwise after the turnplate gap was adjusted. The turnplate temperature was set to 85° C., and temperature scanning started after the temperature was held for 2 min Shearing deformation: 0.001% to 100%; shearing frequency: 1 Hz; cooling rate: 5° C./min; and target temperature: 25° C. The change in storage modulus G′ and loss modulus G″ was recorded.

The gel formed in this example has high strength, and a storage modulus (G′) and loss modulus (G″) respectively of 38 Pa and 7.7 Pa (see FIG. 2).

(3) Preparation of Emulsifying Pectin

3a. Pretreatment of raw material: The residue obtained in step 2b was ground into a paste with a wet grinder. The solid material in the grinder had a particle size of 500 μm. The paste was then mixed with a dilute acid solution at a paste-to-solution ratio of 1:20 (g:L). The soaking was conducted at 75° C. for 2 h under mechanical stirring at 150 rpm, with a pH of 2.5. The mixture obtained after the soaking stood for 2 h.

3b. Separation of liquid and residue: The supernatant obtained in step 3a was filtered to give a pectin liquid for later use.

3c. Concentration: The pectin liquid was concentrated using a filter membrane to a volume ¼ of the original volume. The filter membrane had a pore size of 80 KD.

3d. Drying: The pectin concentrate was spray-dried to remove moisture to give emulsifying pectin.

The determination results are shown in Table 1. The emulsifying pectin includes 68% of galacturonic acid and 5.1% of protein, and has DM and DA of 32% and 16%, respectively.

Preparation Method of Emulsion

Emulsion formula: pectin: 1% (mass concentration), corn oil: 15% (mass concentration).

The pH of the pectin solution was adjusted to 3.5 with a 1M sodium hydroxide solution, and then an oil-in-water emulsion was prepared with a nano-microjet homogenizer (Nano DeBEE, BEE, USA), with a homogenization pressure of 50 MPa, and 2 cycles.

Method for determining the average particle size of emulsion: The MS3000 laser particle size analyzer was used to determine the average particle size of the emulsion. The emulsion was slowly dispersed in deionized water until the shading degree was 6%, and then the average particle size of the emulsion was determined.

The corn oil has a refractive index and absorption rate of 1.45 and 0.001, respectively; and the continuous phase is water, which has a refraction coefficient and absorption coefficient of 1.33 and 0.01, respectively.

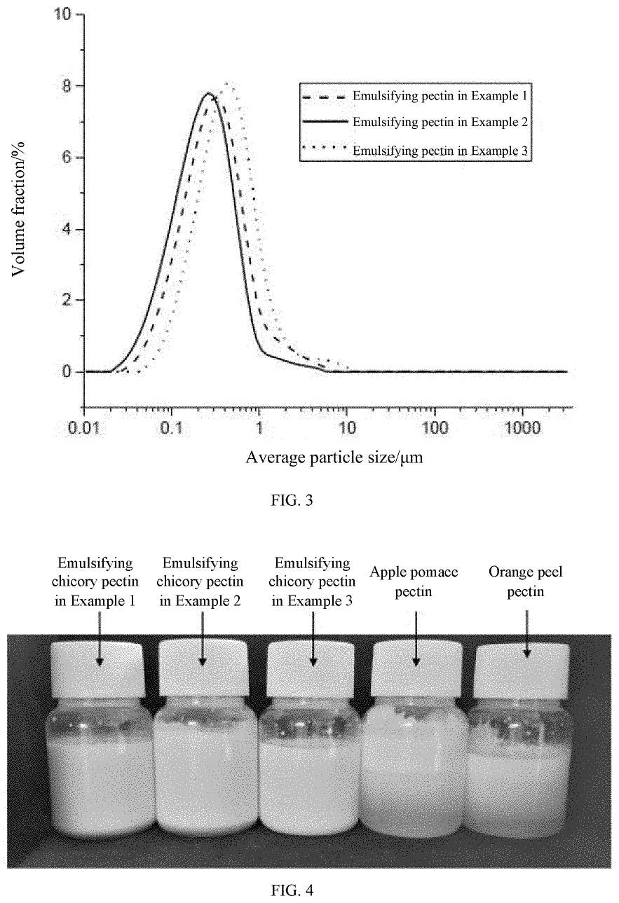

Due to the presence of hydrophobic structures such as acetyl groups and glycoproteins, the pectin in this example has excellent emulsifying properties. In an oil-in-water emulsion with a corn oil mass concentration of 5% to 20%, adding 0.5% to 2% (mass concentration) of emulsifying chicory pectin can achieve a prominent emulsification effect, and the obtained emulsion has an average particle size of 0.426 μm (FIG. 3). Compared with the commercial apple and orange peel pectins, the emulsifying chicory pectin produced in the disclosure will not be separated into layers after being stored at room temperature for 1 month (FIG. 4), and exhibits better emulsifying properties.

TABLE 1
The chemical composition and molecular weight of the gelling
and emulsifying chicory pectins obtained in Example 1

| | | | Product from |
|---|---|---|---|
| | Gelling | Emulsifying | the traditional |
| | pectin | pectin | hot acid method |
| Moisture content (% w/w) | 8.0 | 7.2 | 9.3 |
| Galacturonic acid (% w/w) | 76.3 | 68 | 71.1 |
| Protein (% w/w) | 1.8 | 5.1 | 2.4 |
| Ash (% w/w) | 2.4 | 1.4 | 3.2 |
| DM (mol %) | 34 | 32 | 32 |
| DA (mol %) | 7 | 16 | 14 |
| WAMW (kg/mol) | 440 | 213 | 350 |
| Storage modulus (G′, Pa) | 38 | / | 27 |
| Loss modulus (G″, Pa) | 7.7 | / | 9.2 |

The extraction conditions of the traditional hot acid method are as follows: extraction solvent: HNO₃, pH of the system: 1.5, material-to-solvent ratio: 1:20, extraction temperature: 80° C., and extraction time: 60 min.

As shown in Table 1, compared with the product prepared by the traditional hot acid method, the gelling chicory/Jerusalem artichoke pectin produced by the method of this example has a DA decreasing from 14% to 7%, which helps the product to form a stronger gel network structure with Ca²⁺. As shown in FIG. 2, the gelling chicory/Jerusalem artichoke pectin produced in this example is a cryogenic gel. When the system has a temperature lower than 60° C., the storage modulus G′ is significantly higher than the loss modulus G. When the system has a temperature of 25° C., the solution turns into a typical gel, at which point, the storage modulus G′ is about 5 times the loss modulus G. Compared with the product produced by the traditional hot acid method, the gelling product obtained in this example has a storage modulus G′ increasing from 27 Pa to 38 Pa and a loss modulus G″ decreasing from 9.2 Pa to 7.7 Pa, and exhibits a significantly-improved gel-forming ability.

It can be seen from the test results in Table 1 that the disclosure helps to improve the purity of the product. The obtained gelling pectin has a galacturonic acid content increasing from 71.1% to 76.3%, a WAMW increasing from 350 kg/mol to 440 kg/mol, and an ash content decreasing from 3.2% to 2.4%. The emulsifying chicory/Jerusalem artichoke pectin exhibits a high protein content (5.1%), a high DA (16%), a low molecular weight (213 kg/mol), and superior emulsifying properties. There has been no report on emulsifying chicory/Jerusalem artichoke pectin at home and abroad.

In order to compare the homogeneity of the molecular structure of the product obtained in the disclosure with that of the product prepared by the traditional hot acid method, the molecular weight distribution curve was determined by GPSEC for the products. As shown in FIG. 6, the molecular weight distribution curves of the gelling and emulsifying products obtained in Example 1 are significantly different from that of the product prepared by the traditional hot acid method, indicating that the method of the disclosure leads to a different production effect from the traditional hot acid method. Compared with the product prepared by the traditional hot acid method, the gelling product in Example 1 has a narrower molecular weight distribution curve, indicating a more uniform molecular structure. Moreover, the molecular weight distribution curve of the emulsifying pectin in Example 1 has characteristics that are completely different from that of the product prepared by the traditional hot acid method. For the emulsifying pectin in Example 1, in addition to the solvent peak, the molecular weight distribution curve consists of three peaks, which represent the pectin components with large, medium, and small molecular sizes from left to right, respectively. Different components contribute differently to emulsification characteristics. The macromolecular component has the glycoprotein structure, and the protein covalently bonding to a glycan is the key factor to give the product emulsification activity. The other two components include a small amount of free protein, which helps reduce the surface tension at the oil/water interface.

In this example, the same raw material is used to prepare emulsifying and gelling pectins at the same time, which makes the best use of a material. Compared with the traditional hot acid method, this example adopts the salt method and gas stirring method to produce gelling chicory pectin, which requires mild extraction conditions, allows the extraction pH to fluctuate within a small range, and avoids the degradation of pectin molecules under the action of hot acids and mechanical shearing. The resulting gelling product has a stronger gel strength.

This example uses the method of membrane concentration and direct spray-drying of the concentrate to prepare emulsifying pectin, which avoids the alcohol precipitation-washing-precipitation, filtration and drying in the traditional process. This technology can save a lot of ethanol and water, avoid the high energy consumption of alcohol recovery and the discharge of bottom liquid, and ensure the safety and environmental friendliness of production.

### Example 2

(1) Pretreatment of raw material: Fresh Jerusalem artichoke was washed, cut into shreds, and then soaked in purified water at 80° C. for 1 h. The liquid and the residue were separated by a plate and frame filter press. The residue was rinsed with water until the rinse was clear; then sugar and other impurities were removed from the residue; and the resulting residue was drained and oven-dried to give Jerusalem artichoke pulp. The obtained dry Jerusalem artichoke pulp had the following main components: 23% of cellulose, 23% of hemicellulose, 0.9% of lignin, 29% of pectin, 6% of protein, and 0.45% of ash. The Jerusalem artichoke pulp was crushed and sieved through a 60-mesh sieve for later use.

(2) Preparation of Gelling Pectin

2a. Soaking in a chelating agent solution: 20 kg of the Jerusalem artichoke pulp was mixed with 600 L of sodium hexametaphosphate (SHMP) solution (with a mass concentration of 0.35%). The Jerusalem artichoke pulp and the SHMP solution had a w/v ratio of 1:30 (g:L). Soaking was conducted at 90° C. for 1.5 h, with an extraction pH of 5.5. Gas stirring was conducted during the soaking process to achieve a rotational speed of 200 rpm.

2b. Separation of liquid and residue: The mixture obtained after the soaking in a chelating agent solution was subjected to solid-liquid separation in a plate and frame filter press for 25 min to give a pectin liquid, and the residue was reserved for later use.

2c. Concentration: The pectin liquid was concentrated to have a volume ¼ of the original volume in a vacuum concentration tank. The concentration was conducted at 61° C. under a pressure of −0.075 Mpa.

2d. Alcohol precipitation: The pectin concentrate was mixed with 93% (volume concentration) ethanol at a volume ratio of 1:2.5, and a resulting mixture was stirred for 20 min and then hold for 3 h.

2e. Washing: The pectin precipitate was collected and then washed with an ethanol solution with a volume fraction of 75%. The ethanol solution was used at a volume 2.5 times that of the pectin precipitate.

2f. Drying: To give gelling pectin, the pectin precipitate was dried at 50° C. for 7 h to remove ethanol and moisture.

The gelling pectin includes 77% of galacturonic acid, exhibiting a high purity, and has a DM and DA of 36% and 8%, respectively (Table 2). Therefore, the pectin is low-ester pectin. At a mass concentration of 0.8% and a temperature of 35° C., the gelling pectin can form a colorless and transparent gel with 30 mM Ca²⁺ (FIG. 1), which has a high gel strength, and a storage modulus (G′) and loss modulus (G″) of 43 Pa and 7.8 Pa, respectively.

(3) Preparation of Emulsifying Pectin

3a. Dilute acid extraction: 11 kg of the residue obtained in step 2b was mixed with 200 L of dilute nitric acid solution. Soaking was conducted for 1.5 h at 80° C., with a pH of 1.5.

3b. Separation of liquid and residue: The mixture was filtered by a ZD300 plate and frame filter press at 0.3 Mpa to give a pectin liquid and residue, and the pectin liquid was reserved for later use.

3c. Concentration: The pectin liquid was concentrated using a filter membrane to a volume ¼ of the original volume. The filter membrane had a pore size of 20 KD.

3d. Drying: To give emulsifying pectin, the pectin concentrate was spray-dried to remove moisture.

The emulsifying pectin includes 67% of galacturonic acid and 5.6% of protein, and has a DM and DA of 33% and 18%, respectively (Table 2). Due to the presence of hydrophobic structures such as acetyl groups and glycoproteins, the pectin has excellent emulsifying properties. In an oil-in-water emulsion with a corn oil mass concentration of 10%, adding 0.5% (mass concentration) of emulsifying Jerusalem artichoke pulp can achieve a prominent emulsification effect, and the obtained emulsion has an average particle size of 0.320 μm (FIG. 3), and will not be separated into layers after being stored at room temperature for 1 month (FIG. 4).

TABLE 2
The chemical composition and molecular weight of the gelling and
emulsifying Jerusalem artichoke pectins obtained in Example 2

| | Gelling pectin | Emulsifying pectin |
|---|---|---|
| Moisture content (% w/w) | 7.0 | 8.5 |
| Galacturonic acid (% w/w) | 77 | 67 |
| Protein (% w/w) | 1.4 | 5.6 |
| Ash (% w/w) | 2.0 | 1.2 |
| DM (mol %) | 36 | 33 |
| DA (mol %) | 8 | 18 |
| WAMW (kg/mol) | 460 | 235 |

In this example, Jerusalem artichoke pulp is used as a raw material to prepare emulsifying and gelling pectins at the same time. This example adopts the salt method and gas stirring method to produce gelling Jerusalem artichoke pectin, which requires mild extraction conditions, and avoids the degradation of pectin molecules under the action of hot acids and mechanical shearing. The resulting gelling product has a molecular weight increasing from 440 KD to 460 KD, exhibiting excellent gelling properties, and the obtained emulsifying pectin has a molecular weight increasing from 213 KD to 235 KD, exhibiting excellent emulsifying properties.

This example uses the method of membrane concentration and direct spray-drying of the concentrate to prepare emulsifying pectin, which avoids the alcohol precipitation-washing-precipitation, filtration and drying in the traditional process. This technology can save a lot of ethanol and water, avoid the high energy consumption of alcohol recovery and the discharge of bottom liquid, and ensure the safety and environmental friendliness of production.

### Example 3

(1) Pretreatment of raw material: Fresh chicory was washed, cut into shreds, and then soaked in purified water at 80° C. for 1.5 h. The liquid and the residue were separated by a three-column centrifuge (2,000 rpm, 20 min). The residue was rinsed with water until the rinse was clear; then sugar and other impurities were removed from the residue; and the resulting residue was drained and oven-dried to give chicory pulp. The obtained dry chicory pulp had the following main components: 22% of cellulose, 24% of hemicellulose, 1.2% of lignin, 26.7% of pectin, 9% of protein, and 0.33% of ash. The chicory pulp was crushed into fine particles and sieved through a 20-mesh sieve for later use.

(2) Preparation of Gelling Pectin

2a. Soaking in a chelating agent solution: 18 kg of the pretreated chicory pulp was mixed with 500 L of ammonium oxalate solution (0.4 g/L). The chicory pulp and the ammonium oxalate solution had a w/v ratio of 1:25. Soaking was conducted at 82° C. for 2.5 h under mechanical stirring at 250 rpm, with an extraction pH of 5.6.

2b. Separation of liquid and residue: The mixture obtained after the soaking in a chelating agent solution was subjected to solid-liquid separation in a suspended centrifuge at 1,800 rpm for 15 min to give a pectin liquid, and the residue was reserved for later use.

2c. Concentration: The pectin liquid was concentrated to have a volume ⅕ of the original volume in a vacuum concentration tank. The concentration was conducted at 58° C. under a pressure of −0.085 Mpa.

2d. Alcohol precipitation: The pectin concentrate was mixed with 95% (volume concentration) ethanol at a volume ratio of 1:2, and a resulting mixture was stirred for 20 min and then hold for 3 h.

2e. Washing: The pectin precipitate was collected and then washed with an ethanol solution with a volume fraction of 70%. The ethanol solution was used at a volume 3 times that of the pectin precipitate.

2f. Drying: To give gelling pectin, the pectin precipitate was dried at 45° C. for 10 h to remove excess ethanol.

The gelling pectin includes 73% of galacturonic acid, exhibiting a high purity, and has a DM and DA of 37% and 8%, respectively (Table 3). Therefore, the pectin is low-ester pectin. At a mass concentration of 0.6% and a temperature of 28° C., the gelling pectin can form a colorless and transparent gel with 36 mM Ca²⁺ (FIG. 1), which has a high gel strength, and a storage modulus (G′) and loss modulus (G″) of 41 Pa and 8 Pa, respectively.

(3) Preparation of Emulsifying Pectin

3a. Pretreatment of raw material: The residue obtained in step 2b was ground into a paste with a wet grinder. The solid material in the grinder had a particle size of 700 μm. The paste was then mixed with a dilute acid solution at a paste-to-solution ratio of 1:25 (g:L). The soaking was conducted at 72° C. for 2 h under mechanical stirring at 100 rpm, with a pH of 2.3. The mixture obtained after the soaking hold for 3 h.

3b. Separation of liquid and residue: The supernatant obtained in step 3a was filtered to give a pectin liquid for later use.

3c. Concentration: The pectin liquid was concentrated using a filter membrane to a volume ¼ of the original volume. The filter membrane had a pore size of 80 KD.

3d. Drying: To give emulsifying pectin, the pectin concentrate was spray-dried to remove moisture.

As detected, the emulsifying pectin includes 68% of galacturonic acid and 5.3% of protein, and has a DM and DA of 33% and 15%, respectively (Table 3). Due to the presence of hydrophobic structures such as acetyl groups and glycoproteins, the pectin has excellent emulsifying properties. In an oil-in-water emulsion with a corn oil mass concentration of 5% to 20%, adding 62% (mass concentration) of emulsifying chicory pectin can achieve a prominent emulsification effect, and the obtained emulsion has an average particle size of 0.580 μm (FIG. 3), and will not be separated into layers after being stored at room temperature for 1 month (FIG. 4).

TABLE 3
The chemical composition and molecular weight of the gelling
and emulsifying chicory pectins obtained in Example 3

| | Gelling pectin | Emulsifying pectin |
|---|---|---|
| Moisture content (% w/w) | 7.7 | 8.8 |
| Galacturonic acid (% w/w) | 73 | 68 |
| Protein (% w/w) | 1.1 | 5.3 |
| Ash (% w/w) | 2.5 | 1.8 |
| DM (mol %) | 37 | 33 |
| DA (mol %) | 8 | 15 |
| WAMW (kg/mol) | 472 | 233 |

1. A method for co-production of gelling and emulsifying pectins from chicory/Jerusalem artichoke pulp, comprising the following steps:
(1) pretreatment of raw material: removing impurities from chicory pulp, then rinsing with water until the rinse is clear, and drying, crushing and sieving through a 20 to 60 mesh sieve to give the pretreated chicory pulp for later use;
(2) preparation of gelling pectin
2a. soaking in a chelating agent solution: mixing the chicory pulp with a chelating agent solution at a mass-volume ratio (kg:L) of 1:20 to 1:30, and conducting soaking at 60° C. to 90° C. for 1 h to 4 h, with an extraction pH of 5.5 to 6.0, wherein, gas stirring is conducted during the soaking process to achieve a rotational speed of 60 rpm to 500 rpm, and the chelating agent is ammonium oxalate or sodium hexametaphosphate;
2b. separation of liquid and residue: separating the liquid and the residue by filtration or centrifugation to give a pectin liquid, and reserving the residue for later use;
2c. concentration: concentrating the pectin liquid to a volume ⅓ to ⅕ of the original volume;
2d. alcohol precipitation: mixing the pectin concentrate with 80% to 95% ethanol at a volume ratio of 1:1 to 1:5, stirring a resulting mixture for 10 min to 30 min, and then standing for 1 h to 6 h;
2e. washing: collecting the pectin precipitate, and then washing the pectin with an ethanol solution;
2f. drying: removing ethanol to give gelling pectin;
(3) preparation of emulsifying pectin
3a. pretreatment of raw material: grinding the residue obtained in step 2b into a paste by a wet grinder; then mixing the paste with a dilute acid solution at a mass-volume ratio (kg:L) of 1:10 to 1:30; conducting soaking at 60° C. to 80° C. for 1 h to 3 h under mechanical stirring at 60 rpm to 600 rpm, with a pH of 2 to 3.5; and standing for 1 h to 2 h; wherein, the solid material in the grinder has a particle size of 1 μm to 1,000 μm;
3b. separation of liquid and residue: separating the liquid and residue obtained in step 3a by filtration or centrifugation to give a pectin liquid for later use;
3c. concentration: concentrating the pectin liquid using a filter membrane to a volume ¼ to ⅕ of the original volume, wherein, the filter membrane has a pore size of 1 KD to 200 KD;
3d. drying: spray-drying the pectin concentrate to remove moisture to give emulsifying pectin.

2. The method for co-production of gelling and emulsifying pectins from chicory/Jerusalem artichoke pulp according to claim 1, wherein, the chelating agent solution has a concentration of 0.2 to 1 g/100 mL.

3. The method for co-production of gelling and emulsifying pectins from chicory/Jerusalem artichoke pulp according to claim 1, wherein, the filtration in steps 2b and 3b is conducted by a plate and frame filter press or a leaf filter.

4. The method for co-production of gelling and emulsifying pectins from chicory/Jerusalem artichoke pulp according to claim 1, wherein, the centrifugation in steps 2b and 3b is conducted for 10 min to 60 min by a batch or continuous centrifuge at a rotational speed of 1,000 rpm to 10,000 rpm.

5. The method for co-production of gelling and emulsifying pectins from chicory/Jerusalem artichoke pulp according to claim 1, wherein, the concentration in steps 2c and 3c is conducted under vacuum at 50° C. to 80° C., with a vacuum degree of 0.01 MPa to 0.05 MPa.

6. The method for co-production of gelling and emulsifying pectins from chicory/Jerusalem artichoke pulp according to claim 1, wherein, the ethanol solution used for washing in steps 2e has a concentration of 70% to 90% (v/v).

7. The method for co-production of gelling and emulsifying pectins from chicory/Jerusalem artichoke pulp according to claim 1, wherein, the dilute acid in step 3a is one of hydrochloric acid, nitric acid, sulfuric acid, and citric acid.

8. The method for co-production of gelling and emulsifying pectins from chicory/Jerusalem artichoke pulp according to claim 1, wherein, in steps 2f and 3d, the pectin is dried by one or more of a spray dryer, an airflow dryer, and fluidized bed and airflow dryer.
